(19) United States
(12) Patent Application Publication
(10) Pub. No.: US 2017/0145669 A1
(43) Pub. Date: May 25, 2017

(54) Apparatus for Recycling Water for a Shower or Bath

(71) Applicants: Michael Edward Klicpera, San Diego, CA (US); Ann Marie Butler, San Diego, CA (US)

(72) Inventors: Michael Edward Klicpera, San Diego, CA (US); Ann Marie Butler, San Diego, CA (US)

(21) Appl. No.: 14/887,142

(22) Filed: Oct. 19, 2015

(51) Int. Cl. E03C 1/00; A47K 3/28; C02F 9/00; B01D 29/56; B01D 35/157

(52) U.S. Cl. CPC E03C 1/00; B01D 29/56; B01D 35/1573; C02F 9/00; A47K 3/28; C02F 2101/301

(57) ABSTRACT

The present invention is a system that recycles shower water to promote water conservation. The system comprises a plurality water valves for opening and closing water lines, sensors for temperature and presence of soap/shampoo/conditioner in the water, a heater, a filter means, and a control center. This system has the capability to monitor when the water is clean and then channels water to be recycled and supplemented with heating, filtering, and a percentage of fresh hot and cold (ambient) water. The control center continuously monitors the water for cleanliness or contaminated with soap products and can switch between a recycle mode and a non-recycle mode. The temperature sensor monitors the recycle water temperature and activates a heater to increase the temperature if needed.

### FIELD OF THE INVENTION

This apparatus relates to a water-recycling shower or bath and more particularly relates to a shower apparatus for the recirculation of water in homes, commercial facilities, exercise facilities and the like to effect a conservation of water wherein water, once used in the showering process, is recycled during a portion of the showering process in place of fresh water in order to effect a conservation of water which structure is especially useful under conditions of limited availability of water.

### BACKGROUND OF THE INVENTION

In many parts of the United States and other countries throughout the world, there are either persistent or periodic draught conditions which may last for one or more years. As a result, water becomes a precious commodity. Various governmental institutions, as a matter of necessity, impose restrictions on the quantity of water which may be used. These restrictions generally apply to commercial institutions such as hotels and industrial users, as well as to private users.

Coupled with the problem of rationing is the fact that many municipalities have restrictions on the use of waste water or gray water and also have restrictions on the use of underground water sources since these sources may potentially be contaminated. As a result of these restrictions, and the rationing of water, one of the principal uses to which water conservation is directed is shower wash water.

Governmental regulation, all homes in certain municipalities must be outfitted with flow-restricting shower nozzles which materially reduce the water flow rate and hence, the reduction in the quantity of water which issues from a shower head.

One way to conserve water is to instruct individuals to use shower water only for purposes of rinsing off soap lather, and to cease all water flow during lathering and the like.

The problem of water rationing is particularly pronounced in countries which do not have a large available source of fresh water. Many countries have resorted to the use of desalination plants for purposes of producing fresh water from sea water. However, with the present-day technology, the cost of desalinized water is quite substantial and while there may not be a supply restriction, the cost of the water is quite substantial and therefore, there is an effective economic restriction on the amount of water which can be used in any activity.

Many people are accustomed to and particularly enjoy long showers with an abundance of available hot water. Not only does the flow restricting head reduce the amount of water delivered, but since the flow restrictor literally serves as a restriction in the line, water issues at a substantial pressure. As a result, there is not a soft water flow, but rather a high pressure stream of water which does not produce a pleasing sensation when striking upon a person's body in any significant quantity which users may desire.

In many societies of the world, bathing is often a tradition or a ritual. Thus, even if sources of fresh water are readily available, there is still a cost associated with purification and delivery of water from a public source to private facilities. Thus, water conservation still has substantial cost benefits. Further, the bathing is oftentimes not only a traditional ritual, but does provide many aesthetic benefits, as well as therapeutic benefits. Thus, water recycling has a significant advantage in essentially all societies.

When one replaces a government issued or government approved flow-restricting shower head with another high-flow rate conventional shower head, that person risks potential civil penalties, not to mention the substantial cost for exceeding a rationed limit of water. Hotels and similar institutions have a particularly pronounced problem in that there is no effective control on the quantity of shower water used by a temporary occupant. Nevertheless, hotels and similar institutions are almost always subjected to rationing of water on the same basis as the private population. Consequently, these institutions have a particular need for some mechanism to control the amount of water used or otherwise to provide a water-conserving shower bath system.

In view of the foregoing, there is clearly a need of water rationing in those regions where only a limited amount of fresh water may be available, particularly in vehicles such as boats, planes, trains, submarines, space stations, recreational vehicles, mobile homes and the like. These vehicles in particular are uniquely limited in their ability to provide extended shower capacity, due to the finite capacity of water on board the vehicle, or otherwise the ability of the vehicle to create fresh water. Thus, a water recycling system in this type of environment would be particularly effective.

Showers, bathtubs, and sinks are often equipped with single water outlets which blend hot and cold water. However, in arriving at the water blend of the desired temperature, often a substantial quantity of water flows out of the water outlet and down the drain. The water that flows down the drain is wasteful in a number of ways and clean water is wasted.

The present invention obviates these and other problems in the provision of a water recycling apparatus and method which is highly effective for use in showers and which maintains both energy and water conservation, while greatly improving performance, capacity and satisfaction.

Water conservation is becoming a major issue for many cities and a apparatus for monitoring water usage at a specific residential or corporate site could be useful in supporting water conservation.

### SUMMARY OF THE INVENTION

The present invention is a system that recycles shower or bath water to promote water conservation. The system comprises a plurality water valves for opening and closing water lines, sensors for temperature and presence of soap/shampoo/detergent/conditioner in the water, a heater, a filter means, and a control center. This system has the capability to monitor when the water is clean and then channels water to be recycled and supplemented with heating, filtering, and a percentage of fresh hot and cold (ambient) water. The control center continuously monitors the water for cleanliness or contaminated with soap products and can switch between a recycle mode and a non-recycle mode. The temperature sensor monitors the recycle water temperature and activates a heater to increase the temperature if needed. The contamination sensor monitors for the presence of soap/shampoo/detergent/conditioners and is electronically coupled to one or more diverter valves for computer controlled division of contaminated water and relatively fresh water. The control center is programmable to provide various temperature settings. The control center can also have a LED/LCD/OLED or similar type display that provides shower duration, current time, set temperature, etc. When the shower is first turned on, the system can optional enter into a partial recycle mode or cycle saving water while the water temperature attains the desire comfort level Either prior to starting a shower, or after the shower is complete, or both, the control center activates a sterilization mode which ensures that the shower plumbing is free from bacterial and waste contaminants. This sterilization mode or cycle can be programmed with the control center to set the duration, include the cycle during initial shower warm up period.

### BRIEF DESCRIPTION OF THE DRAWINGS

FIG. 1 is a perspective view of a standard shower have shower head penetrating the shower wall, a water control valve, a drain and a typical P Trap and sewer line.

FIG. 2 is a perspective view of a first embodiment with the present invention apparatus in fluid communication with the standard plumbing pipe.

FIG. 3 is a perspective view of a second embodiment with the present invention apparatus in fluid communication with a recycled drain and associated plumbing pipe.

FIG. 4 is an electrical schematic contained within control center having the main power supply, CPU or microprocessor/microcontroller, an analog or digital display means, a clock circuit, one or more temperature sensors and one or more flow sensors for the first embodiment with a single drain system.

FIG. 5 is an electrical schematic contained within control center having the main power supply, CPU or microprocessor/microcontroller, an analog or digital display means, a clock circuit, one or more temperature sensors and one or more flow sensors for the second embodiment with a multiple drain system.

Corresponding reference characters indicate corresponding parts throughout the several views. The exemplifications set out herein illustrate exemplary embodiments of the invention, and such exemplifications are not to be construed as limiting the scope of the invention in any manner.

### DESCRIPTION OF THE PREFERRED EMBODIMENTS

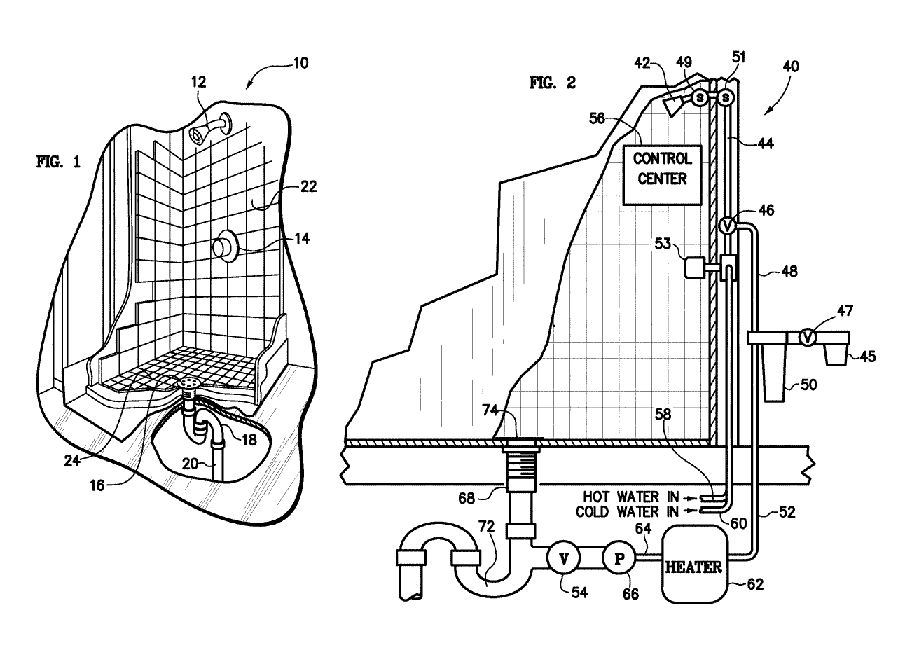

Referring now to the drawings and particularly to FIG. 1 is a perspective view of a typical shower enclosed in housing consisting of two to four walls 22 with a floor 24. Generally, at the lowest point and usual near the center or one edge is the drain 16 that is connection to a P tray 18 that connects to the sewer line 20. A water control valve 14, generally has a hot and cold (ambient) water supply lines in fluid connection and the valve 14 controls the water pressure and the ratio of hot and cold water to the shower. A general shower head 12 exits the wall where the control valve 14 is located. When one begins the shower, generally the control valve 14 is turn on and wasted water is allowed to flow down the drain 16, through the P trap 18, and down the sewer 20, until the water attains the desired temperature ranging in 90-100 degrees Fahrenheit. The duration of the shower is dependent on initial rinsing, body soap application, hair shampoo/conditioner application, various soap rinsing cycles and special occasions such as coloring hair. The entire period the water is on every milliliter goes down the drain and is wasted. A relaxing and long duration can provide traditional therapeutic benefits and general pleasurable feelings but this practice wastes precious water resources.

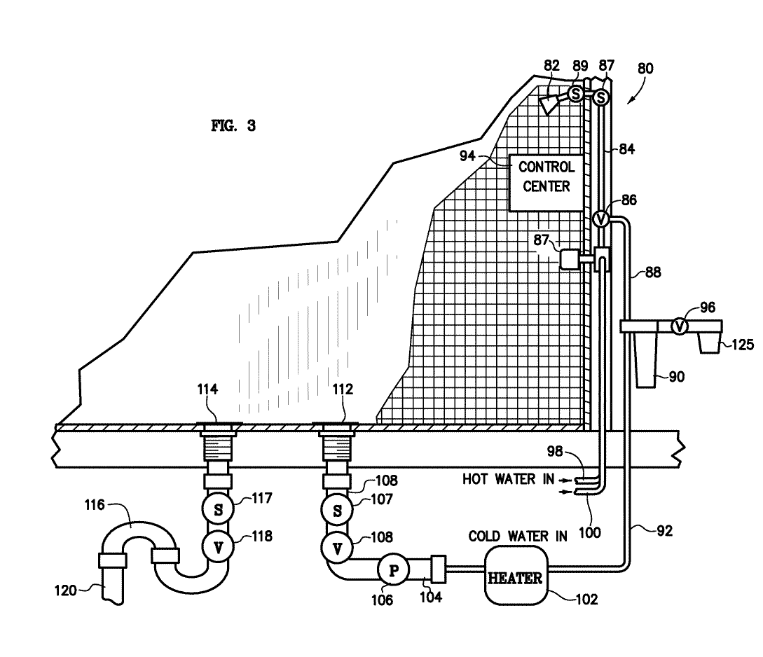

Now referring to FIG. 2 which shows a perspective view of a first embodiment 40 with the present invention apparatus in fluid communication with the standard plumbing pipe. The present shower recycle system is in fluid connection with the original shower drain 74, P trap 72 and sewer line. The water plumbing pipes can be typical metallic piping materials such as brass, brass alloys, steel, galvanized steel, copper, copper allows or any combination thereof. The water plumbing pipes can be a number of polymeric materials, such as polyvinyl chloride (PVC), polyethylene, polybutylene, acryaontirile-butadiene-styrene (ABS), rubber modified styrene, polypropylene, polyacetal, polyethylene, or nylon.

On the bottom of the shower is a drain system 74 that includes a first diverter valve 54 and a contamination sensor 68 are positioned in close proximity to the drain 74. The contamination sensor 68 is in wired or wireless electrical communication with the control center 56. The contamination sensor 68 can consist of a turbidity type sensor, a total dissolved solids (TDS) sensor or an ultrasonic sensor or any other technology that can determine the presence of soap/shampoo/detergent/conditioner or hair color in the waste water entering the drain system 74. Turbidity sensors measure suspended solids in water, typically by measuring the amount of light transmitted through the water. Turbidity sensors are commercial available from numerous companies. The TDS sensor is basically a conductivity meter and the meter measure the water's conductivity and the TDS is calculated by a fixed mathematical formula in the sensor/control center. TDS sensors are commercial available from numerous companies. Ultrasonic sensors use for fluid identification and contamination utilize time of flight (TOF) measurement techniques to monitor material purity/contamination levels and to differentiate materials non-invasively. Ultrasonic TOF sensors are commercial available from companies such as Texas Instruments (TDC1000-C200 EVM with test cell).

When the contamination sensor 68 detects a specified level of determine the presence of soap/shampoo/detergent/conditioner or hair color in the waste water entering the drain system 74, it sends a corresponding electrical signal to the command center that determines if the first diverter valve 54 will direct the water down the sewer side (when soap/shampoo/detergent/conditioner or hair color is detected) and alternately direct the clean waste water (when soap/shampoo/detergent/conditioner or hair color is absent) to the recycle plumbing and filter section. By diverting water with relatively large concentration of soap/shampoo/detergent/conditioner or hair color into sewer side functions to minimize the load and demands on the filter assembly.

Also shown near the shower head 42 is a temperature sensor 49 and a flow sensor 51. In general, a sensor is a type of transducer. A direct type indicating sensor, for example, a mercury thermometer, is human readable but not practical in real time use conditions. Other analog or digital sensors paired with an indicator or display, for instance, thermocouple sensor, are better suited for the requirements of the present invention. Most sensors are electrical or electronic, although other types exist. Technological progress allows for more and more to be manufactured on the microscopic scale as micro-sensors using MEMS technology. In most cases a micro-sensor reaches a significantly higher speed and sensitivity compared with macroscopic approaches. The temperature sensor technology is well known and can be consist of a thermocouple, thermistor, thermometers, bi-metal thermometers and thermostats, heat sensors such as bolometers and calorimeter, microchip temperature sensors, or any similar technology. The flow sensor technology is well known and can consists of an paddle, turbine or impeller type, or ball effect sensor, a pressure sensor, or a non-invasive technology such as ultrasonic (Doppler or time transit), magnetic and laser Doppler water flow sensors.

Exiting the first diverter valve 54 is a water pump 66 which is in fluid communication with a water heater 62 and in electrical communication (wired or wireless) with the control center 56. When the first diverter valve directs the clean waste water to the recycle plumbing side the control center 56 energizes the water pump 66. A pressure valve or sensor (not shown) may be utilized to monitor the water pressures on the recycles side to pulsate or control the water pump 66 to attain a desired water pressure in the recycle plumbing. The pressure valve or sensor may be incorporated into the water pump 66 or exist independent of the water pump 66 in the downstream plumbing. The pressure valve or sensor will also be in wired or wireless communication with the control center 56. The water heater 62 is also in electrical communication (wired or wireless) with the control center 56. Fresh hot 58 and cold (ambient) 60 water enters and is in fluid communication with the control valve 53. The temperature sensor 49 will electronically communicate, wired or wirelessly with the control center 56 to control the heater to attain a desire temperature. A heated supply line 52 exits the water beater 62 and enters a filter assembly 50.

The filter assembly 50 can have a number of treatment components and each treatment component (or treatment layer) can be either be individually or collectively removed for cleaning or removal and replacement. For example, a first treatment section can include a filter apparatus to remove hair, skin cells and relatively large particles and impurities from the recycled water. Any type of diatomaceous earth, sand, or cartridge or filter paper/screen may be used herein and includes felt filter papers, nylon filter paper, membrane filters, and other filter technology known to the skilled artisan. Some pieces of filter may be thicker or thinner, depending upon the flow rate required to achieve sufficient flow characteristics of the present invention. An optional second treatment section can be a halogen removal and pH neutralization section. The second optional treatment can have first layer of activated carbon layer that is designed to remove any soap or detergent, organic impurities and chemicals, and chloromethane which is a source or unpleasant odor in water. Activated carbon is a commercially available product from numerous companies. An optional second layer can include a layer of silver impregnated with activated carbon (silver carbon). The silver carbon primarily serves to remove chlorine and other halogens from water passing through the filter assembly 50. In additional, the silver blocks the growth of bacteria within an optional activated carbon layer and can be installed before and after the optional activated carbon layer. If bacteria were to grow in the activated carbon layer, the filter apparatus 50 would function inefficiently. Silver carbon is a well-known and commercially available product that can be purchased by numerous companies. After the optional activation carbon and/or silver carbon layers a second filter paper could be disposed which aids in filters out any silver or carbon particulates which become entrained in the water. These layers also filter out any remaining chlorine or halogens in the water. After the optional layers of activated carbon and silver carbon is disposed, another optional filter that serves further to distribute to filter out any impurities that may have passed through the previous filter papers. Below this additional optional filter is an optional filter layer of redox alloy. Redox alloy is a well-known and commercially available product. The redox alloy will function to kill any microbiological contaminants (bacteria, viruses and organic materials in the water. Additional layers or

Disposed below the first treatment section, is an optional second treatment section. The second treatment section optionally starts with a filter that serves to further filter out any impurities that may have passed through the previous filter. After the filter is an optional layer of iodine particles or resin. The iodine particles or resin, which may be of the trivalent, pentavalent, or septivalent variety or a combination of these, serves to kill microbiological contaminants in the water, such as viruses and bacteria. Iodine particles or resin with an odd valence are used because the intramolecular bonds of the bacteria and viruses are weaker than those of iodine molecules, and the weaker bonds will allow the iodine to attack microorganisms more quickly. Odd-valence iodine is a well-known and commercially available product. This section of the filter can include a hybrid of odd-valence and even-valence iodine may also be used. After the layer of iodine particles or resin is disposed an optional remaining filter. The remaining filter paper serves further to filter out any impurities that may have passed through the previous filter. An optional ion-exchange treatment can be included within the filter assembly 50 to further treat the water removing metallic compounds.

From the filter assembly 50 is the water output line 44 which supplies water at a comfortable temperature to shower head 42. It is anticipated by the Applicants that the different treatments of the filter can be used at different times. For example, the halogen removal and pH neutralization section can be used when the sterilization components or agents are used. Also, certain filter stages can by bypassed when the monitored water is relatively clean and a large recycle flow is necessary. The Applicant understands that it will be necessary to replace the used filter assembly 50 with an new filter assembly 50 or that methods will be used to clean the filter assembly 50. An opening door or other means will be available to access the one or more of the filter assemblies for the removal/replacement or cleaning process.

The filter assembly 50 is required to have a high flow rate to properly function with the system and it is generally used to remove non-soluble particulates, such as hair, skin cells, etc. One or multiple filter and sterilization technology can be utilized with the present invention. Water output line 44 supplies water at a comfortable temperature to shower head 42.

A water supply line 48 leaves the filter assembly 50 and connects to a controllable and adjustable three-way valve 46. Also in fluid communication with this supply line 48 is a temperature sensor 49 and an optional flow sensor 51. The temperature sensor 49 and the optional flow sensor 51 are in electronic communication, either wired or wireless, the command center 56. Also in fluid communication with this supply line 48 is a sterilization or bio-resistance method storage tank 45 with activation valve 47. The sterilization, disinfection or bio-resistance method storage tank can contain compounds or combinations of chlorine, bromine, hydrogen peroxide, iodine, use UV and ultra UV lighting, steam or very hot water, hydrogen generation from irradiated semiconductor-liquid interfaces or the water can have a salinity that allows chlorine electrical generation. It is anticipated by the Applicants that other forms or sterilization, disinfection or bio-resistance methods could be used such other methods such as high and extreme heating condition either directly (heaters) or indirectly applied by liquid or gaseous (steam), ultraviolet light techniques and other known sterilization or bio-resistance methods. This storage tank 45 is utilized to supply certain components to the filter assembly 50 and/or used to provide the final cleaning step whereby after the shower, the control center initiates one or more steps that automatically runs a cycle with the sole purpose of cleaning and sterilization the system. It is anticipated by the Applicants that the drain system 74 prior to the “P” trap 72 can be filed with a sterilization solution and allowed to remain for a period of time by closing the first valve 50. The temperature sensor 49, the flow sensor 51, the first diverter valve 54, a controllable and adjustable three-way valve 46, the pump 66, the heater 62 and the activation valve 47 are in electrical communication with the control center 56. The three-way valve 46 connects the original water supply lines 58, 60, the recycled water supply line 48, and the output water supply line 44. The second valve 46 can have the capability to bleed partial hot 58 and cold water 60 with recycled water 48 as controlled by the control center 56. Also shown is the standard control valve 53.

The control center 56 is programmable to provide various temperature settings flow rates and timing parameters. The material for fabricating the control center housing 56 is not particularly important except has waterproofing and be of sufficient size and weight to contain the electrical and power components housing. The size of the display means will generally determine the size of the housing but it does not have to be substantially rectangular as shown, any number of geometric configurations could be used in the present invention. The control center 56 has a display, monitoring and control functionality and includes characteristics other than displaying and monitoring time, temperature and water flow (e.g., passwords, language, alarms, acoustic loudness, display brightness, sensor calibration, etc.) for any of a variety of different water conservation systems. The electronic display of the control center 56 may dynamically display a digital numerical value representative of the identified parameter values.

The control center 56 can have adaptable remote display, monitor and/or control apparatus with a touch-screen display in a round, square, rectangle or other configuration utilizing LED, LCD, OMLED or other display technology and including a housing that cooperates with the valves, pumps, heaters, sterilization tanks with one or more microprocessors/microcontrollers, housing, and rear surface attachment means designed to communicate by wired or wireless technology to a remotely located valves, pumps, heaters, sterilization tanks water and may include flow sensor, temperature sensor and timing circuit attached to or in close proximity to a water supply.

The optional display (not shown) utilizes one or more illuminating technologies, such as LCD, LED OLED, gas plasma, fluorescence, incandescent, halogen, halide, or other lighting technologies but must able to provide sufficient lighting for observing the data in shower conditions. The display means mounted in the control center housing 56 must be able to sustain capability in moist wet conditions. The present invention can include one or more than one display parameter. For example, a unit with only the temperature display can be manufactured to reduce overall costs. Furthermore, the orientation of the parameters resented can be changed, for example, the flow parameter can be on top with the time parameter on the bottom and with the temperature parameter sandwiched between. The displays can have a background light that is used for various purposes, for example, for providing better lighting conditions or changing color e.g. from green to red, to display an alarming condition. Displaying of all water parameters can utilize a gang multiple LCD, LED, gas plasma, fluorescence, incandescent, halogen, halide, or other lighting technologies separate displays, custom displays, graphic displays or a single line display which sufficient digits that sequences the presentation of the water parameters 42, 44, and 46 one at a time with a specific delay and sequencing. An example of a LCD unit that can be used with the present invention is the color graphic 128×128 LCD-00569 marketed by Sparkfun Electronics in Boulder, Colo. It is anticipated by the Applicants that there are other variants and other LCD, LED, gas plasma, fluorescence, incandescent, halogen, halide, or other lighting technologies that can be utilized with the present invention.

It is anticipated by the Applicant the present invention can be fabricated and marketed with one, two or more display means. For example, a lower cost display assembly can be fabricated and sold that only has a temperature sensor and temperature display means. A more expensive display assembly can be fabricated and sold that has temperature, flow, timing and other sensors with various programmed methods and a shut off mechanism.

One or more ergonomically placed buttons or activators can be incorporated into the control center 56 housing to allow the modification of certain parameter units (e.g. metric to US), set alarm conditions (e.g. temperature over-set point), or to program certain settings, e.g. total shower time before shutdown or alarm, monitor continuous leakage (valve not complete shut off). The buttons will electrically communicate with the electronic circuit board contained with the housing and respond to programmed instructions integrated within the CPU or microprocessor and associated circuitry of the electronic circuit board. The buttons or activators (not shown) should be mounted with the display means housing with the capability to protect the buttons and electronic circuitry with the housing for exposure to moist and wet conditions.

A visual alarm can be incorporated into the present invention whereby a preset alarm or programmed alarm, changes the screen display, for example, blinking a parameter, or changing the color of a parameter (green to red). A preset alarm might include visual reference, for example, if the system is in the standard mode or in the recycle mode, or for example, an in-operative condition, broken sensor, low power source and some default limits. The visual alarm can also be used to indicate the sterilization, disinfection or bio-resistance method is on.

In addition, an auditory alarm can be incorporated into the present invention whereby a preset alarm or programmed alarm, changes the screen display, for example, using sound or pulsing a specific noise, or changing the color of a parameter. For example, the temperature display can change from green to red when a preset temperature is crossed. A preset alarm might include visual reference if the system is in the standard mode or the recycle mode, or for example, an in-operative condition, broken sensor, low power source and some default limits. The auditory alarm can also be used to indicate the sterilization, disinfection or bio-resistance method is on.

The control center 56 may include a housing designed to be mounted on various surfaces such as glass surface, a wall surface, a mirror surface, wood beam, a metal surface, a plastic surface, a ceramic surface, a tile surface, a panel surface, a wall paper surface. The housing can be fabricated from a metallic material such as brass, brass alloys, steel, galvanized steel, copper, copper allows or any combination thereof. The housing can be fabricated from a number of polymeric materials, such as polyvinyl chloride (PVC), polyethylene, polybutylene, acryaontirile-butadiene-styrene (ABS), rubber modified styrene, polypropylene, polyacetal, polyethylene, or nylon. The base material can be painted white or colored finishes or coated with various brass, silver and gold type materials to an appealing finish. It is anticipated by the Applicants that an adhesive connection frame will be the more permanently mounted whereby the housing be designed to engaged this connection frame.

It is to be appreciated that while one or more embodiments is detailed herein are designed for use within a residential home, such as a single-family house, the scope of the present teachings is not so limited, the present teachings being likewise applicable, without limitation, to duplexes, townhomes, multi-unit apartment buildings, hotels, retail stores, office buildings, industrial buildings, and more generally any living space or work space having one or more water conservation systems. It is to be further appreciated that while the terms user, customer, installer, homeowner, occupant, guest, tenant, landlord, repair person, and the like may be used to refer to the person or persons who interacting with the present invention apparatus in the context of some particularly advantageous situations described herein, these references are by no means to be considered as limiting the scope of the present teachings with respect to the person or persons who are performing such actions. Thus, for example, the terms user, customer, purchaser, installer, subscriber, and homeowner may often refer to the same person in the case of a single-family residential dwelling, because the head of the household is often the person who makes the purchasing decision, buys the unit, and installs and configures the unit, However, in other scenarios, such as a landlord-tenant environment, the customer may be the landlord with respect to purchasing the unit, the installer may be a local apartment supervisor, a first user may be the tenant, and a second user may again be the landlord with respect to remote control functionality.

The control center 56 can be programmed to display one or more parameters in a visual means that can be either an analog, character or digital display, or combination of display means. Information obtained from the appropriate sensor monitoring or measuring the water parameters such as temperature, shower time (water on), and flow rate can be displayed in an appropriate format on the display means. For example, when a sensor is monitoring the shower temperature of water flowing through the shower head, the display means could show any temperature between 32 degrees Fahrenheit (0 degrees Celsius) and 212 degrees Fahrenheit (100 degrees Celsius), and within a reasonable range of 50 degrees Fahrenheit (10.0 degrees Celsius) and 150 degrees Fahrenheit (65.5 degrees Celsius). For example, when a sensor is monitoring or measuring the rate of water flowing from a water source or through the shower head, the display means could show any flow between 0 gal/min (0 liters/hr) and 100 gal/min, within a reasonable range of 0.2 gal/min (liter/min) to 20 gal/min (liters/min). In additional, when a sensor is monitoring or measuring the rate of water flowing from a water source or through the shower head, the display means could show the total volume of water that has been used, e.g. 23 gallons. Furthermore, the display can be programmed to display calendar information, such as the date and current time (12 hr. or 24 hr. format).

The mode of operation focuses around the control center 56. The control center 56 includes a CPU, microprocessor or microcontroller with software instructions and associated circuitry mounted on one or more electronic circuit boards to communicate and/or control the display means, communicate with the sensors, pumps, beaters and control valves and perform the operations defined herein. The electronic communication between the control center 56 and the various sensors, pumps, valves and pumps can be hard wired or utilize wireless technology. Kinds of wireless protocols to be used with the present invention include WiFi, Bluetooth and Zigbee and other protocols are possible. For example, there is the ISM (industrial, scientific and medical) bands. The ISM bands are defined by the ITU-R in 5.138, 5.150, and 5.280 of the Radio Regulations. Individual countries' use of the bands designated in these sections may differ due to variations in national radio regulations. Because communication devices using the ISM bands must tolerate any interference from ISM equipment, these bands are typically given over to uses intended for unlicensed operation, since unlicensed operation typically needs to be tolerant of interference from other devices anyway. In the United States of America, ISM uses of the ISM bands are governed by Part 18 of the FCC rules, while Part 15 Subpart B contains the rules for unlicensed communication devices, even those that use the ISM frequencies. Part 18 ISM rules prohibit using ISM for communications.

The ISM bands defined by the ITU-R are:

| | | Center | |
|---|---|---|---|
| Frequency range [Hz] | | frequency [Hz] | Availability |
| 6.765-6.795 | MHz | 6.780 MHz | Subject to local acceptance |
| 13.553-13.567 | MHz | 13.560 MHz | |
| 26.957-27.283 | MHz | 27.120 MHz | |
| 40.66-40.70 | MHz | 40.68 MHz | |
| 433.05-434.79 | MHz | 433.92 MHz | Region 1 only |
| 902-928 | MHz | 915 MHz | Region 2 only |
| 2.400-2.500 | GHz | 2.450 GHz | |
| 5.725-5.875 | GHz | 5.800 GHz | |
| 24-24.25 | GHz | 24.125 GHz | |
| 61-61.5 | GHz | 61.25 GHz | Subject to local acceptance |
| 122-123 | GHz | 122.5 GHz | Subject to local acceptance |
| 244-246 | GHz | 245 GHz | Subject to local acceptance |

While currently the 430 MHz and 900 MHz frequencies, WiFi, Bluetooth and Zigbee are commonly used in the US, it is anticipated by the Applicants that the other frequencies could be used for water parameter transfers.

Another protocol known as CAN or CAN-bus (ISO 11898-1) that was originally designed for automotive applications, but now moving into industrial applications is another type of network that could be used to transfer water parameter data. Devices that are connected by a CAN network are typically sensors, actuators and control devices. A CAN message never reaches these devices directly, but instead a host-processor and a CAN Controller is needed between these devices and the bus.

The CPU or microprocessor and associated circuitry mounted on an electronic circuit board has programmed instruction for controlling the operations of monitoring sensor, operating control valves and performing sterilization operations. The control center 56 senses that the water is turned on (by monitoring one the soap sensor 49 and/or flow sensor 51 and if programmed accordingly, performs a number of operations. First, to conserve water, the control center 46 regulates the first valve 54 and pump 66 to recycle a portion of the water. Second, an initial optional sterilization cycle or mode can be activated which, by way of controlling second activation valve 46, can bleed the sterilization components which can be controllably released into the water (or turn on UV lights to expose portions of the piping) to create a sterilization solution that encounters the drain and association plumbing to minimize contamination that can be introduced during the recycle mode or cycle. Once the water attains the desired temperature programmed in the control center 46, a full recycle mode or cycle is activated and the activation valve 46 is closed. An alarm, visual or auditory, in the control center 46 can signal when the desired temperature is attained.

During the full recycle mode or cycle, the control center 56 is continuously monitoring the soap/detergent/shampoo/conditioner sensor 68 and adjusting first diverter valve 54 and water pressure pump 66 as necessary. When soap/shampoo/detergent/conditioner is sensed by the sensor 68 that is overloading the designed filter apparatus 50 or be too much volume or concentration, the first diverter valve 54 is closed and all the contaminate water flows freely down the original drain 74, P trap 72 and sewer line. The control center 56 can be simultaneously monitoring the water temperature with the temperature sensor 49, and the flow sensor 51 and display the temperature and flow rate on a LED, LCD, OLED or similar display apparatus. When soap, shampoo or conditioner is absent and not sensed by the soap/detergent/shampoo/conditioner sensor 68, then the control center 56 automatically open diverter valve 54 to direct recycled water to pump 66, which feeds water to water line 64 and to the heater 62. The full recycle mode can be programmed in the control center to be delayed for a period of time such that only fresh water is provide during this period. The control center 56, constantly monitors the water temperature through sensor 49, controls the heater 62 to achieve the desire temperature setting. The control center 56, constantly monitors the pressure (using a pressure sensor, pump back voltage or other method) and maintains the pressure with pressure pump 66 to maintain adequate pressure for the shower. Non-fresh recycled water is then optionally transfer through the filter 50 and to second control valve 46. Second control valve 46 is automatically opened during the full recycle mode by the control center 56 or can bleed in fresh water with the recycled water as determined by the control center 56. During the shower duration, soap, shampoo, conditioner, hair color or other contaminates may be introduced into the system. The control center will immediately recognize this condition and stop the recycle mode by closing first diverter valve 54 and adjust the controllable and adjustable three-way valve 46 to select the source hot 58 and cold 60 water, and turn off pump 66 and heater 62. Once the water is free of contaminates, the control center can revert back to recycle mode. This changing operation can occur numerous times during the shower duration.

When the shower duration if over, and the water supply is turn off by the control valve 54, an optional programmable hold over period will wait until the optional sterilization cycle is begun. If the sterilization cycle is selected, the control valve 54 is activated by the control center and the first diverter valve 54 and second control valve 46 are opened. Pump 66 and heater 62 may be energized and the controllable and adjustable three-way valve 46 will be opened for a programmable period of time to cycle sterilizing components into the water steam, or exposed all or part of the system to a sterilizing UV light source, to minimize bacterial and other contaminates from the drain 74, and the recycle plumbing system.

Now referring to FIG. 3 which shows a perspective view of a second embodiment 80 with the present invention apparatus in fluid communication with the standard plumbing pipe. The second embodiment includes a separate drain 114 and its own P trap 116, and sewer line 120 will function normally when the first diverter valve 118 is open. The water plumbing pipes can be typical metallic piping materials such as brass, brass alloys, steel, galvanized steel, copper, copper allows or any combination thereof. The water plumbing pipes can be a number of polymeric materials, such as polyvinyl chloride (PVC), polyethylene, polybutylene, acryaontirile-butadiene-styrene (ABS), rubber modified styrene, polypropylene, polyacetal, polyethylene, or nylon. A first diverter valve 118 and a soap/detergent/shampoo/conditioner sensor 117 are positioned in close proximity to the drain 114. The soap/shampoo/detergent/conditioner sensor 117 is in electrical communication with the control center 94. The soap/detergent/shampoo/conditioner sensor can consist of a turbidity type sensor, a total dissolved solids (TDS) sensor or an ultrasonic sensor. Turbidity sensors measure suspended solids in water, typically by measuring the amount of light transmitted through the water. Turbidity sensors are commercial available from numerous companies. The TDS sensor is basically a conductivity meter and the meter measure the water's conductivity and the TDS is calculated by a fixed mathematical formula in the sensor/control center. TDS sensors are commercial available from numerous companies. Ultrasonic sensors use for fluid identification and contamination utilize time of flight (TOF) measurement techniques to monitor material purity/contamination levels and to differentiate materials non-invasively. Ultrasonic TOF sensors are commercial available from companies such as Texas Instruments (TDC1000-C200 EVM with test cell).

The recycle drain 112 includes a second diverter valve 108 and a pneumatic or other type pump 106 which is in fluid communication with a water heater 102 and in electrical communication (wired or wireless) with the control center 94. The water heater 102 is also in electrical communication (wired or wireless) with the control center 94. Fresh hot 98 and cold (ambient) 100 water enters and is in fluid communication with the control valve 87. A heated supply line 92 exits the water heater 102 and enters a filter assembly 90.

The filter assembly 90 can have a number of treatment components. For example, a first treatment section can include a filter apparatus to remove hair, skin cells and relatively large particles and impurities from the recycled water. Any type of filter or filter paper may be used herein and includes felt filter papers nylon filter paper, membrane filters and other filter technology known to the skilled artisan. Some pieces of filter may be thicker or thinner, depending upon the flow rate required to achieve sufficient flow characteristics of the present invention. An optional second treatment section can be a halogen removal and pH neutralization section. The second filter can include a layer of silver impregnated with activated carbon (silver carbon). The silver carbon primarily serves to remove chlorine and other halogens from water passing through the filter assembly 50. In additional, the silver blocks the growth of bacteria within an optional activated carbon layer (described below). If bacteria were to grow in the activated carbon layer, the filter apparatus 90 would function inefficiently. Silver carbon is a well-known and commercially available product that can be purchased by numerous companies. After the optional silver carbon layer, a second filter could be disposed which aids in filters out any silver or carbon particulates which become entrained in the water. These layers also filter out any remaining chlorine or halogens in the water. The next optional layer is an activated carbon layer that is designed to remove any soap or detergent, organic impurities and chemicals, and chloromethane which is a source or unpleasant odor in water. Activated carbon is, also, a commercially available product from numerous companies. After the optional layer of activated carbon is disposed a fourth filter that serves further to distribute to filter out any impurities that may have passed through the previous filter papers. Below the fourth filter is an optional filter layer of redox alloy. Redox alloy is a well-known and commercially available product. The redox alloy will function to kill any microbiological contaminants (bacteria, viruses and organic materials in the water.

Disposed below the first treatment section, is an optional second more specific microbiological treatment section. The second treatment section starts with an optional sixth filter that serves to further filter out any impurities that may have passed through the previous filter. After the sixth filter is an optional layer of iodine particles or resin. The iodine particles or resin, which may be of the trivalent, pentavalent, or septivalent variety or a combination of these, serves to kill microbiological contaminants in the water, such as viruses and bacteria. Iodine particles or resin with an odd valence are used because the intramolecular bonds of the bacteria and viruses are weaker than those of iodine molecules, and the weaker bonds will allow the iodine to attack microorganisms more quickly. Odd-valence iodine is a well-known and commercially available product. This section of the filter can include a hybrid of odd-valence and even-valence iodine may also be used. After the layer of iodine particles or resin is disposed an optional seventh filter. The seventh filter paper serves further to filter out any impurities that may have passed through the previous filter. An optional ion exchange treatment can be included within the filter assembly 50 to further treat the water removing metallic compounds.

From the filter assembly 90 is the water output line 84 which supplies water at a comfortable temperature to shower head 82. It is anticipated by the Applicants that the different treatments of the filter can be used at different times. For example, the halogen removal and pH neutralization section can be used when the sterilization components or agents are used. Also, certain filter stages can by bypassed when the monitored water is relatively clean and a large recycle flow is necessary. The Applicant understands that it will be necessary to replace the used filter assembly 90 with a new filter assembly 90 or that methods will be used to clean the filter assembly 90. An opening door or other means will be available to access the filter assembly for the replacement or cleaning process.

The filter assembly 90 is required to have a high flow rate to properly function with the system and it is generally used to remove non-soluble particulates, such as hair, skin cells, etc. One or multiple filter and sterilization technology can be utilized with the present invention. Water output line 84 supplies water at a comfortable temperature to shower head 82.

A water supply line 88 leaves the filter assembly 90 and connects to a second valve 86. Also in fluid communication with this supply line 88 is a temperature sensor 89 and a flow sensor 87. Also in fluid communication with this supply line 88 is a sterilization or bio-resistance method storage tank 125 with activation valve 96. The sterilization, disinfection or bio-resistance method storage tank 125 can contain compounds or combinations of chlorine, bromine, hydrogen peroxide, iodine, use UV and ultra UV lighting, steam or very hot water, hydrogen generation from irradiated semiconductor-liquid interfaces or the water can have a salinity that allows chlorine electrical generation. It is anticipated by the Applicants that other forms or sterilization, disinfection or bio-resistance methods could be used such other methods such as high and extreme heating condition either directly (heaters) or indirectly applied by liquid or gaseous (steam), ultraviolet light techniques and other known sterilization or bio-resistance methods. This storage tank 125 is utilized to supply certain components to the filter assembly 90 and/or used to provide the final cleaning step whereby after the shower, the control center initiates one or more steps that automatically runs a cycle with the sole purpose of cleaning and sterilization the system. It is anticipated by the Applicants that the recycle drain system 112 and piping 104 can be filed with a sterilization solution and allowed to remain for a period of time by closing the second diverter valve 108 (and potentially also the first diverter valve 118). The temperature sensor 89, the flow sensor 87, the first diverter valve 108, the second divert valve 118, the controllable and adjustable three-way valve 86, the pump 106, the heater 102 and the activation valve 96 are in electrical communication with the control center 94. The controllable and adjustable three-way valve 86 connects the original water supply lines 98, 100, the recycled water supply line 88, and the output water supply line 84. The controllable and adjustable three-way valve 86 can have the capability to bleed partial hot 98 and cold water 100 with recycled water 88 as controlled by the control center 94. Also shown is the standard control valve 87.

The control center 94 is programmable to provide various temperature settings flow rates and timing parameters. The material for fabricating the control center housing 94 is not particularly important except has waterproofing and be of sufficient size and weight to contain the electrical and power components housing. The size of the display means will generally determine the size of the housing but it does not have to be substantially rectangular as shown, any number of geometric configurations could be used in the present invention. The control center 94 has a display, monitoring and control functionality and includes characteristics other than displaying and monitoring time, temperature and water flow (e.g., passwords, language, alarms, acoustic loudness, display brightness, sensor calibration, etc.) for any of a variety of different water conservation systems. The electronic display of the control center 56 may dynamically display a digital numerical value representative of the identified parameter values.

The control center 94 can have adaptable remote display, monitor and/or control apparatus with a touch-screen display in a round, square, rectangle or other configuration utilizing LED, LCD, OMLED or other display technology and including a housing that cooperates with the valves, pumps, heaters, sterilization tanks with one or more microprocessors/microcontrollers, housing, and rear surface attachment means designed to communicate by wired or wireless technology to a remotely located valves, pumps, beaters, sterilization tanks water and may include flow sensor, temperature sensor and timing circuit attached to or in close proximity to a water supply.

The optional display (not shown) utilizes one or more illuminating technologies, such as LCD, LED OLED, gas plasma, fluorescence, incandescent, halogen, halide, or other lighting technologies but must able to provide sufficient lighting for observing the data in shower conditions. The display means mounted in the control center housing 56 must be able to sustain capability in moist wet conditions. The present invention can include one or more than one display parameter. For example, a unit with only the temperature display can be manufactured to reduce overall costs. Furthermore, the orientation of the parameters resented can be changed, for example, the flow parameter can be on top with the time parameter on the bottom and with the temperature parameter sandwiched between. The displays can have a background light that is used for various purposes, for example, for providing better lighting conditions or changing color e.g. from green to red, to display an alarming condition. Displaying of all water parameters can utilize a gang multiple LCD, LED, gas plasma, fluorescence, incandescent, halogen, halide, or other lighting technologies separate displays, custom displays, graphic displays or a single line display which sufficient digits that sequences the presentation of the water parameters one at a time with a specific delay and sequencing. An example of a LCD unit that can be used with the present invention is the color graphic 128×128 LCD-00569 marketed by Sparkfun Electronics in Boulder, Colo. It is anticipated by the Applicants that there are other variants and other LCD, LED, gas plasma, fluorescence, incandescent, halogen, halide, or other lighting technologies that can be utilized with the present invention.

It is anticipated by the Applicant the present invention can be fabricated and marketed with one, two or more display means. For example, a lower cost display assembly can be fabricated and sold that only has a temperature sensor and temperature display means. A more expensive display assembly can be fabricated and sold that has temperature, flow, timing and other sensors with various programmed methods and a shut off mechanism.

One or more ergonomically placed buttons or activators can be incorporated into the control center 94 housing to allow the modification of certain parameter units (e.g. metric to US), set alarm conditions (e.g. temperature over-set point), or to program certain settings, e.g. total shower time before shutdown or alarm, monitor continuous leakage (valve not complete shut off). The buttons will electrically communicate with the electronic circuit board contained with the housing 20 and respond to programmed instructions integrated within the CPU or microprocessor and associated circuitry of the electronic circuit board. The buttons or activators (not shown) should be mounted with the capability to protect the buttons and electronic circuitry with the housing for exposure to moist and wet conditions.

A visual alarm can be incorporated into the present invention whereby a preset alarm or programmed alarm, changes the screen display, for example, blinking a parameter, or changing the color of a parameter (green to red). A preset alarm might include visual reference, for example, if the system is in the standard mode or in the recycle mode, or for example, an in-operative condition, broken sensor, low power source and some default limits. The visual alarm can also be used to indicate the sterilization, disinfection or bio-resistance method is on.

In addition, an auditory alarm can be incorporated into the present invention whereby a preset alarm or programmed alarm, changes the screen display, for example, using sound or pulsing a specific noise, or changing the color of a parameter. For example, the temperature display can change from green to red when a preset temperature is crossed. A preset alarm might include visual reference if the system is in the standard mode or the recycle mode, or for example, an in-operative condition, broken sensor, low power source and some default limits. The auditory alarm can also be used to indicate the sterilization, disinfection or bio-resistance method is on.

The control center 94 may include a housing designed to be mounted on various surfaces such as glass surface, a wall surface, a mirror surface, wood beam, a metal surface, a plastic surface, a ceramic surface, a tile surface, a panel surface, a wall paper surface. The housing can be fabricated from a metallic material such as brass, brass alloys, steel, galvanized steel, copper, copper allows or any combination thereof. The housing can be fabricated from a number of polymeric materials, such as polyvinyl chloride (PVC), polyethylene, polybutylene, acryaontirile-butadiene-styrene (ABS), rubber modified styrene, polypropylene, polyacetal, polyethylene, or nylon. The base material can be painted white or colored finishes or coated with various brass, silver and gold type materials to an appealing finish. It is anticipated by the Applicants that an adhesive connection frame will be the more permanently mounted whereby the housing be designed to engaged this connection frame.

It is to be appreciated that while one or more embodiments is detailed herein are designed for use within a residential home, such as a single-family house, the scope of the present teachings is not so limited, the present teachings being likewise applicable, without limitation, to duplexes, townhomes, multi-unit apartment buildings, hotels, retail stores, office buildings, industrial buildings, and more generally any living space or work space having one or more water conservation systems. It is to be further appreciated that while the terms user, customer, installer, homeowner, occupant, guest, tenant, landlord, repair person, and the like may be used to refer to the person or persons who interacting with the present invention apparatus in the context of some particularly advantageous situations described herein, these references are by no means to be considered as limiting the scope of the present teachings with respect to the person or persons who are performing such actions. Thus, for example, the terms user, customer, purchaser, installer, subscriber, and homeowner may often refer to the same person in the case of a single-family residential dwelling, because the head of the household is often the person who makes the purchasing decision, buys the unit, and installs and configures the unit, However, in other scenarios, such as a landlord-tenant environment, the customer may be the landlord with respect to purchasing the unit, the installer may be a local apartment supervisor, a first user may be the tenant, and a second user may again be the landlord with respect to remote control functionality.

The control center 94 can be programmed to display one or more parameters in a visual means that can be either an analog, character or digital display, or combination of display means. Information obtained from the appropriate sensor monitoring or measuring the water parameters such as temperature, shower time (water on), and flow rate can be displayed in an appropriate format on the display means. For example, when a sensor is monitoring the shower temperature of water flowing through the shower head, the display means could show any temperature between 32 degrees Fahrenheit (0 degrees Celsius) and 212 degrees Fahrenheit (100 degrees Celsius), and within a reasonable range of 50 degrees Fahrenheit (10.0 degrees Celsius) and 150 degrees Fahrenheit (65.5 degrees Celsius). For example, when a sensor is monitoring or measuring the rate of water flowing from a water source or through the shower head, the display means could show any flow between 0 gal/min (0 liters/hr) and 100 gal/min, within a reasonable range of 0.2 gal/min (liter/min) to 20 gal/min (liters/min). In additional, when a sensor is monitoring or measuring the rate of water flowing from a water source or through the shower head, the display means could show the total volume of water that has been used, e.g. 23 gallons. Furthermore, the display can be programmed to display calendar information, such as the date and current time (12 hr. or 24 hr. format).

The mode of operation focuses around the control center 94. The control center 94 includes a CPU, microprocessor or microcontroller with software instructions and associated circuitry mounted on one or more electronic circuit boards to communicate and/or control the display means, communicate with the sensors, pumps, heaters and control valves and perform the operations defined herein. The electronic communication between the control center 94 and the various sensors, pumps, valves and pumps can be hard wired or utilize wireless technology. Kinds of wireless protocols to be used with the present invention include WiFi, Bluetooth and Zigbee and other protocols are possible. For example, there is the ISM (industrial, scientific and medical) bands. The ISM bands are defined by the ITU-R in 5.138, 5.150, and 5.280 of the Radio Regulations. Individual countries' use of the bands designated in these sections may differ due to variations in national radio regulations. Because communication devices using the ISM bands must tolerate any interference from ISM equipment, these bands are typically given over to uses intended for unlicensed operation, since unlicensed operation typically needs to be tolerant of interference from other devices anyway. In the United States of America, ISM uses of the ISM bands are governed by Part 18 of the FCC rules, while Part 15 Subpart B contains the rules for unlicensed communication devices, even those that use the ISM frequencies. Part 18 ISM rules prohibit using ISM for communications.

The ISM bands defined by the ITU-R are:

| | | Center | |
|---|---|---|---|
| Frequency range [Hz] | | frequency [Hz] | Availability |
| 6.765-6.795 | MHz | 6.780 MHz | Subject to local acceptance |
| 13.553-13.567 | MHz | 13.560 MHz | |
| 26.957-27.283 | MHz | 27.120 MHz | |
| 40.66-40.70 | MHz | 40.68 MHz | |
| 433.05-434.79 | MHz | 433.92 MHz | Region 1 only |
| 902-928 | MHz | 915 MHz | Region 2 only |
| 2.400-2.500 | GHz | 2.450 GHz | |
| 5.725-5.875 | GHz | 5.800 GHz | |
| 24-24.25 | GHz | 24.125 GHz | |
| 61-61.5 | GHz | 61.25 GHz | Subject to local acceptance |
| 122-423 | GHz | 122.5 GHz | Subject to local acceptance |
| 244-246 | GHz | 245 GHz | Subject to local acceptance |

While currently the 430 MHz and 900 MHz frequencies, WiFi, Bluetooth and Zigbee are commonly used in the US, it is anticipated by the Applicants that the other frequencies could be used for water parameter transfers.

Another protocol known as CAN or CAN-bus (ISO 11898-1) that was originally designed for automotive applications, but now moving into industrial applications is another type of network that could be used to transfer water parameter data. Devices that are connected by a CAN network are typically sensors, actuators and control devices. A CAN message never reaches these devices directly, but instead a host-processor and a CAN Controller is needed between these devices and the bus.

The CPU, microprocessor and/or microcontroller and associated circuitry mounted on an electronic circuit board has programmed instruction for controlling the operations of monitoring sensor, operating control valves and performing sterilization operations. The control center 95 senses that the water is turned on (by monitoring the soap sensors 107 and 117 and/or flow sensor 51 and if programmed accordingly, performs a number of operations. First, to conserve water, the control center 94 regulates the first valve 118 and pump 106 to recycle a portion of the water. Second, an initial optional sterilization cycle or mode can be activated which, by way of controlling second activation valve 96, can bleed the sterilization components which can be controllably released into the water (or turn on UV lights to expose portions of the piping) to create a sterilization solution that encounters the drain and association plumbing to minimize contamination that can be introduced during the recycle mode or cycle. Once the water attains the desired temperature programmed in the control center 94, a fall recycle mode or cycle is activated and the activation valve 96 is closed. An alarm, visual or auditory, in the control center 94 can signal when the desired temperature is attained.

During the full recycle mode or cycle, the control center 94 is continuously monitoring the soap/detergent/shampoo/conditioner sensors 107, 117 and adjusting first diverter valve 118 and water pressure pump 106 as necessary. When soap/shampoo/detergent/conditioner is sensed by the sensor 107, 117 that is overloading the designed filter apparatus 90 or be too much volume or concentration, the second diverter valve 108 is closed and second diverter valve 118 is opened, and all the contaminate water flows freely down the original drain 114, P trap 116 and sewer line 120. The control center 94 can be simultaneously monitoring the water temperature with the temperature sensor 89, and the flow sensor 87 and display the temperature and flow rate on a LED, LCD, OLED or similar display apparatus. When soap, shampoo or conditioner is absent and not sensed by the soap/detergent/shampoo/conditioner sensors 107, 117, then the control center automatically engages second diverter valve 108 to direct recycled water to pump 106, through pump 106 and into water line to the heater 102. The full recycle mode can be programmed in the control center to be delayed for a period of time such that only fresh water is provide during this period. The control center 94, constantly monitors the water temperature through sensor 89, controls the heater 102 to achieve the desire temperature setting. The control center 94, constantly monitors the pressure (using a pressure sensor, pump back voltage or other method) and maintains the pressure with pressure pump 106 to maintain adequate pressure for the shower. Non-fresh recycled water is then optionally transfer through the filter 90 and to controllable and adjustable three-way valve 86. The controllable and adjustable three-way valve 86 is automatically opened during the full recycle mode by the control center 94 or can bleed in fresh water with the recycled water as determined by the control center 94. During the shower duration, soap, shampoo, conditioner, hair color or other contaminates may be introduced into the system. The control center will immediately recognize this condition and stop the recycle mode by closing the second diverter valve 108 and open the diverter valve 118, and turn the controllable and adjustable three-way valve 86 to select the source hot 98 and cold 100 water, and turn off pump 66 and heater 62. Once the water is free of contaminates, the control center can revert back to recycle mode. This changing operation can occur numerous times during the shower duration.

When the shower duration if over, and the water supply is turn off by the control valve 87, an optional programmable hold over period will wait until the optional sterilization cycle is begun. If the sterilization cycle is selected, the first divert valve 118 is closed by the control center and the second diverter valve 108 and controllable and adjustable three-way valve 86 are opened. Pump 66 and heater 62 may be energized and the activation valve 96 will be opened for a programmable period of time to cycle sterilizing components into the water steam, or exposed all or part of the system to a sterilizing UV light source, to minimize bacterial and other contaminates from the drain 112 (and 114), and the recycle plumbing system.

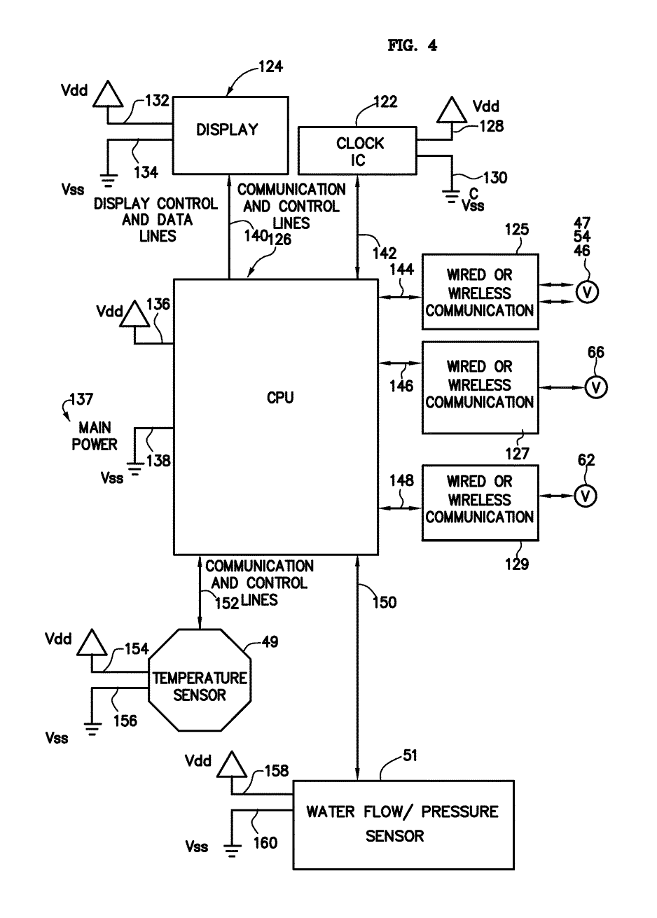

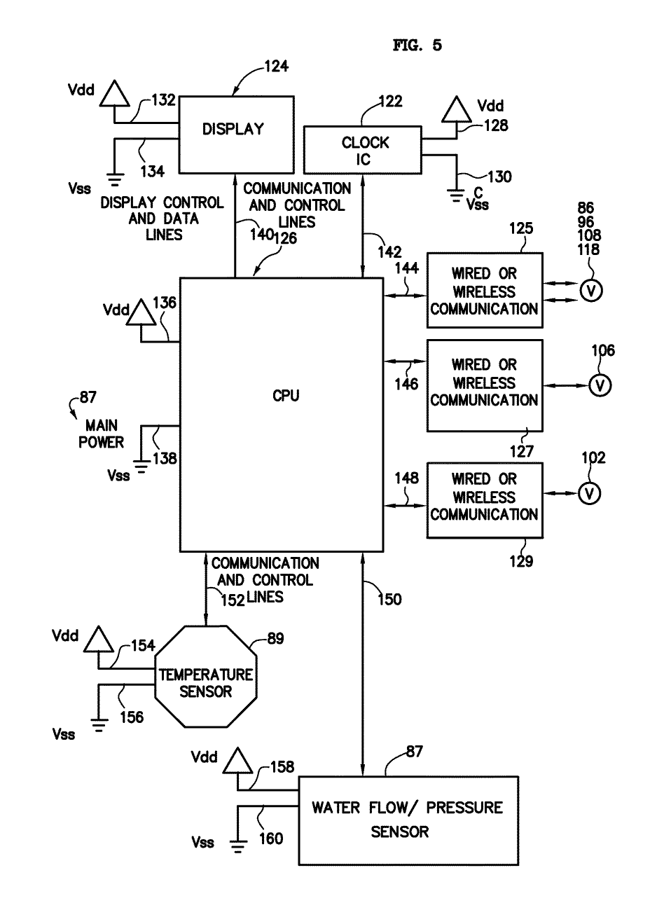

FIG. 4 shows, for the first embodiment with a single drain system, an electrical schematic, for the first embodiment, depicting the main power 137, power supply line 136 and the ground line 138 for CPU, microprocessor and/or microcontroller 126, the CPU, microprocessor and/or microcontroller 126 and the analog or digital display means 124 with a data transfer means 140 and with a power line 132 and a ground line 134.

Also shown in FIG. 4 is a timing clock integrated circuit 122 with data transfer means 142 for communicating with the CPU, microprocessor and/or microcontroller 126 and having a power line 128 and ground line 130, a temperature sensor 49 with a data transfer means 152 for communicating with the CPU, microprocessor and/or microcontroller 126 and having a power line 154 and ground 156, and the flow sensor (pressure) sensor 51 with a data transfer means 150 for communicating with the CPU, microprocessor and/or microcontroller 126 with a power line 158 and ground line 160. The integrated circuits for the timing clock 122, temperature sensor 49 and flow sensor 51 can include circuitry to convert analog data to a digital format.

The CPU, microprocessor and/or microcontroller 126 that processes the information supplied by the temperature sensor 49, flow sensor 51 and timing circuit 122 uses internal instructions to control the information projected on the display 124 and for processing alarm states. The microprocessor can include an EEPROM or any type of memory section that allows for specific programming to be incorporated as processing instructions. Furthermore, the microprocessor may have the capability to convert analog signals into digital information for decoding and processing. An example of a microprocessor that could be used for the CPU or microprocessor is the PIC16F876 28-pin 8-Bin CMOS FLASH micro-controllers manufactured by Microchip Technology, Inc. This particular microprocessor has a 128K EEPROM Data memory bank for flash memory of specific instructions and utilizes a 35-word instruction set. It also has five 10-bit Analog-to-Digital Inputs that can provide the means for converting the information obtained from the temperature sensor 49, flow sensor 51, and/or timing circuit 122 from its analog format into a digitized form for processing by the instruction sets of the CPU, microprocessor and/or microcontroller 126. Another example of a microprocessor that could be used for the CPU or microprocessor is the MSP430 family of processors from Texas Instruments in Dallas, Tex. There are hundreds of variants but for an example, the MSP430F436IPN (80 pin package) or MSP430F436IPZ (100 pin package) could be utilized in the present invention. There are many other variants or other microprocessors, whether commercially marketed or privately fabricated, that can be used with the present invention.

As shown in this FIG. 4 is a first wired or wireless communication 125 having a data or signal transfer means 144 that controls the first diverter valve 54, adjustable three-way valve 46, and activation valve 47. A second wired or wireless communication 127 having a data or signal transfer means 146 that control the pump 66. And a third wired or wireless communication 129 having a data or signal transfer means 148 that controls the heater 62.

FIG. 5 shows an electrical schematic, for the second embodiment, depicting the main power 137, power supply line 136 and ground line 138 for CPU, microprocessor and/or microcontroller 126, the CPU, microprocessor and/or microcontroller 126 and the analog or digital display means 124 with a data transfer means 140 and with a power line 132 and a ground line 134.

Also shown in FIG. 5, for the second embodiment with a multiple drain system, is a timing clock integrated circuit 122 with data transfer means 142 for communicating with the CPU, microprocessor and/or microcontroller 126 and having a power line 128 and ground line 130, a temperature sensor 89 with a data transfer means 152 for communicating with the CPU, microprocessor and/or microcontroller 126 and having a power line 154 and ground 156, and the flow sensor (pressure) sensor 87 with a data transfer means 150 for communicating with the CPU, microprocessor and/or microcontroller 126 with a power line 158 and ground line 160. The integrated circuits for the timing clock 122, temperature sensor 89 and flow sensor 87 can include circuitry to convert analog data to a digital format.

The CPU, microprocessor and/or microcontroller 126 that processes the information supplied by the temperature sensor 89, flow sensor 87 and timing circuit 122 uses internal instructions to control the information projected on the display 124 and for processing alarm states. The microprocessor can include an EEPROM or any type of memory section that allows for specific programming to be incorporated as processing instructions. Furthermore, the microprocessor may have the capability to convert analog signals into digital information for decoding and processing. An example of a microprocessor that could be used for the CPU or microprocessor is the PIC16F876 28-pin 8-Bin CMOS FLASH micro-controllers manufactured by Microchip Technology, Inc. This particular microprocessor has a 128K EEPROM Data memory bank for flash memory of specific instructions and utilizes a 35-word instruction set. It also has five 10-bit Analog-to-Digital Inputs that can provide the means for converting the information obtained from the temperature sensor 89, flow sensor 87, and/or timing circuit 122 from its analog format into a digitized form for processing by the instruction sets of the CPU, microprocessor and/or microcontroller 126. Another example of a microprocessor that could be used for the CPU or microprocessor is the MSP430 family of processors from Texas Instruments in Dallas, Tex. There are hundreds of variants but for an example, the MSP430F436IPN (80 pin package) or MSP430F436IPZ (100 pin package) could be utilized in the present invention. There are many other variants or other microprocessors, whether commercially marketed or privately fabricated, that can be used with the present invention.

As shown in this FIG. 5 is a first wired or wireless communication 125 having a data or signal transfer means 144 that controls the first diverter valve 118, a second diverter valve 108, adjustable three-way valve 86, and activation valve 96. A second wired or wireless communication 127 having a data or signal transfer means 146 that control the pump 106. And a third wired or wireless communication 129 having a data or signal transfer means 148 that controls the heater 102.

While this invention has been described as having a preferred design, the present invention can be further modified within the spirit and scope of this disclosure. The application is therefore intended to cover any variations, uses, or adaptations of the invention using its general principles. Further, this application is intended to cover such departures from the present disclosure as come within known or customary practice and the art to which this invention pertains and which fall within the limits of the appended claims.

1. A recycle shower apparatus:
a water drain that has both typical “P” trap sewer line and a diverting piping, said diverting piping including a control valve, a water pump, a heater and a recycle water supply line;
a controllable and adjustable three-way valve;
a standard hot and cold water supply connected to said three-way valve, said three-way valve also connected to the recycle water supply line;
one or more contaminate sensors, said contaminate sensor capable of monitoring the concentration of soap, detergent, condition, hair color, and/or other contaminates in the water;
a filter apparatus;
a temperature sensor;
a flow sensor; and
a control center has a CPU, microprocessor and/or a microcontroller, electrical circuitry and software instructions, said control center in electrical communication with said control valve, said water pump, said heater, said one or more contaminate sensors, said temperature sensor and said flow sensor, said electrical communication in wired or wireless format, said microprocessor and/or microcontroller having the capability to perform monitoring and control functions.

2. The recycle shower apparatus of claim 1, wherein said wireless communication is in Bluetooth format, WiFi format or Zigbee format.

3. The recycle shower apparatus of claim 1, further comprising that said control center has a display mechanism that can exhibit status, timing, temperature and/or flow parameters.

4. The recycle shower apparatus of claim 1, further comprising including sterilization components for sanitizing a portion of the drain system.

5. The recycle shower apparatus of claim 4, wherein said sterilization component compromises a solution of chlorine, bromide, iodine, or hydrogen peroxide, and combinations thereof.

6. The recycle shower apparatus of claim 4, wherein said sterilization component compromises UV and ultra UV lighting.

7. The recycle shower apparatus of claim 4, wherein said sterilization component compromises a hydrogen generation from irradiation semiconductor-liquid interface.

8. The recycle shower apparatus of claim 5, wherein said chlorine is generated from a chlorine electrical generation system.

9. The recycle shower apparatus of claim 4, wherein a sterilization cycle is performed when the shower is first initiated.

10. The recycle shower apparatus of claim 4, wherein a sterilization cycle is performed after the shower is completed.

11. A recycle shower apparatus:
a standard water drain with a first diverter valve;
a recycle water drain with a second diverter valve;
a controllable and adjustable three-way valve;
a standard hot and cold water supply connected to said three-way valve, said three-way valve also connected to the recycle water supply line;
one or more contaminate sensors, said contaminate sensor capable of monitoring the concentration of soap, detergent, condition, hair color, and/or other contaminates in the water;
a filter apparatus;
a temperature sensor;
a flow sensor; and
a control center has a CPU, microprocessor and/or a microcontroller, electrical circuitry and software instructions, said control center in electrical communication with said control valve, said water pump, said heater, said one or more contaminate sensors, said temperature sensor and said flow sensor, said electrical communication in wired or wireless format, said microprocessor and/or microcontroller having the capability to perform monitoring and control functions.

12. The recycle shower apparatus of claim 11, wherein said wireless communication is in Bluetooth format, WiFi format or Zigbee format.

13. The recycle shower apparatus of claim 11, further comprising that said control center has a display mechanism that can exhibit status, timing, temperature and/or flow parameters.

14. The recycle shower apparatus of claim 11, further comprising including sterilization components for sanitizing a portion of the drain system.

15. The recycle shower apparatus of claim 14, wherein said sterilization component compromises a solution of chlorine, bromide, iodine, or hydrogen peroxide, and combinations thereof.

16. The recycle shower apparatus of claim 14, wherein said sterilization component compromises UV and ultra UV lighting.

17. The recycle shower apparatus of claim 14, wherein said sterilization component compromises a hydrogen generation from irradiation semiconductor-liquid interface.

18. The recycle shower apparatus of claim 15, wherein said chlorine is generated from a chlorine electrical generation system.

19. The recycle shower apparatus of claim 14, wherein a sterilization cycle is performed when the shower is first initiated.

20. The recycle shower apparatus of claim 14, wherein a sterilization cycle is performed after the shower is completed.
